(19) United States
(12) Patent Application Publication
(10) Pub. No.: US 2025/0247768 A1
(43) Pub. Date: Jul. 31, 2025

(54) ADAPTIVE SERVICE SUPPORT FOR SATELLITE NETWORK ACCESS

(71) Applicant: T-Mobile USA, Inc., Bellevue, WA (US)

(72) Inventors: Derrick L. Ives, North Bend, WA (US); Mehul Shah, Bellevue, WA (US)

(21) Appl. No.: 18/424,441

(22) Filed: Jan. 26, 2024

(51) Int. Cl. H04W 48/04; H04B 7/185; H04W 48/16

(52) U.S. Cl. CPC H04W 48/04; H04W 48/16; H04B 7/1851

(57) ABSTRACT

Techniques related to providing adaptive services to users when user devices are connected to satellite networks are disclosed. In one example aspect, a device for wireless communication comprises at least one processor that is configured to receive information about a network condition associated with a satellite access network, adaptively enable or disable a service feature according to the network condition, and notify a user of the device that the service feature is adaptively enabled or disabled.

### BACKGROUND

Satellite Internet access is provided through communication satellites. Modern consumer grade satellite Internet service is typically provided to individual users through geostationary satellites that can offer relatively high data speeds.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 illustrates an example configuration of satellite network access in accordance with one or more embodiments of the present technology.

FIG. 4 illustrates an example signaling sequence for a user device to obtain satellite network conditions in accordance with one or more embodiments of the present technology.

FIG. 5A illustrates an example signaling sequence for a user device to subscribe satellite network conditions changes in accordance with one or more embodiments of the present technology.

FIG. 5B illustrates an example signaling sequence for a user device to receive an update of network conditions in accordance with one or more embodiments of the present technology.

FIG. 6A illustrates an example User Interface (UI) on a mobile phone in accordance with one or more embodiments of the present technology.

FIG. 6B illustrates another example UI on a mobile phone in accordance with one or more embodiments of the present technology.

FIG. 6C illustrates another example UI on a mobile phone in accordance with one or more embodiments of the present technology.

FIG. 7A illustrates an example signaling sequence for an application to query the network condition from an operating system of a device in accordance with one or more embodiments of the present technology.

FIG. 7B illustrates an example signaling sequence for an application to subscribe to network condition updates in accordance with one or more embodiments of the present technology.

FIG. 8A illustrates an example UI on a mobile phone in accordance with one or more embodiments of the present technology.

FIG. 8B illustrates another example UI on a mobile phone in accordance with one or more embodiments of the present technology.

FIG. 9 is a flowchart representation of a method for wireless communication in accordance with one or more embodiments of the present technology.

FIG. 10 is a flowchart representation of another method for wireless communication in accordance with one or more embodiments of the present technology.

FIG. 11 is a flowchart representation of yet another method for wireless communication in accordance with one or more embodiments of the present technology.

FIG. 12 is a block diagram that illustrates an example of a computer system in which at least some operations described herein can be implemented.

The technologies described herein will become more apparent to those skilled in the art by studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Satellite networks, also referred to as non-terrestrial networks, are becoming a highly dynamic market with the development 5G technology. Satellite network access has opened new possibilities for connecting people and devices across the world, especially in remote and underserved locations. The Third-Generation Partnership Project (3GPP) Rel-17 specifications, for example, support New Radio (NR) based satellite access deployed in Frequency Range 1 (FR1) bands serving handheld devices for global service continuity.

However, satellite networks are currently bandwidth constrained and there is a high degree of variability of network capacity and/or bandwidth. This patent document discloses techniques that can be implemented in various embodiments to determine appropriate service level(s) for users based on the network conditions and provide users with corresponding notifications, thereby improving user experience when devices are connected to satellite networks. The disclosed techniques can also enable third-party applications installed on the user device to make appropriate decisions about the application-level features available to the users based on the network conditions.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

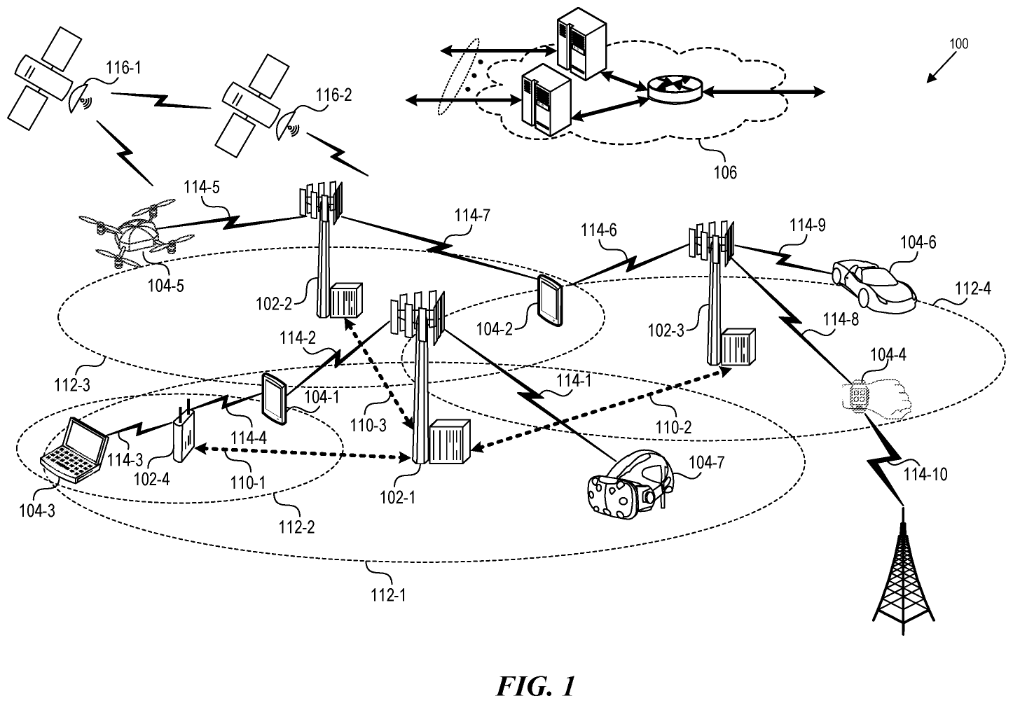

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet-of-Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally, or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QOS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

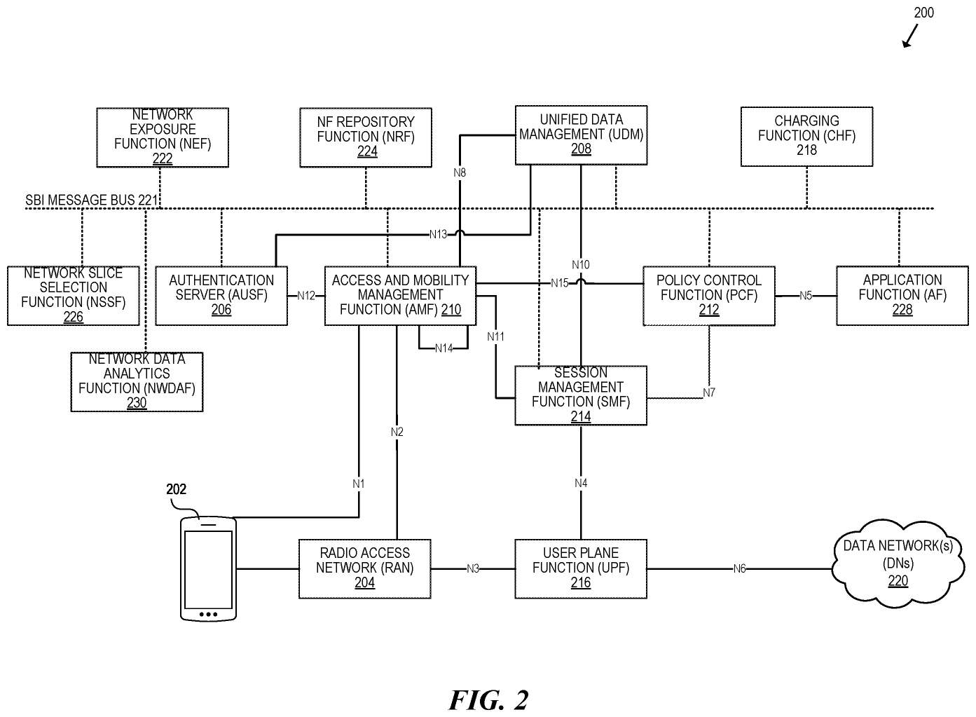

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNS) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, Network Data Analytics Function (NWDAF) 230, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under the Third-Generation Partnership Project (3GPP) Technical Specification 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Adaptive Service Levels for Satellite Network Access

There are several types of satellites available in satellite networks: geostationary, medium-Earth orbit, and low-Earth orbit. As compared to terrestrial networks, satellite networks exhibit high degree of variability in the connectivity and/or bandwidth availability. For example, satellites operating in a low Earth orbit need to maintain their orbits. In some cases, a satellite may only be visible for a maximum of a few minutes to any single ground station. The highly dynamic nature of satellite constellations introduces significant variability in the underlying network characteristics, leading to high bandwidth variability for users. The bandwidth variability is also impacted by user side demand. For example, many users may want to obtain satellite network service at Yellowstone at the summertime, while the demand for such service at wintertime may drop significantly.

In view of the variability in satellite networks, this patent document discloses techniques that can be implemented in various embodiments to help determine appropriate service level(s) for users based on the network conditions. In some scenarios, it is desirable to restrict certain services (e.g., data services) when the network condition is less than ideal. For example, download or upload requests can be postponed/queued for future execution when the network condition improves.

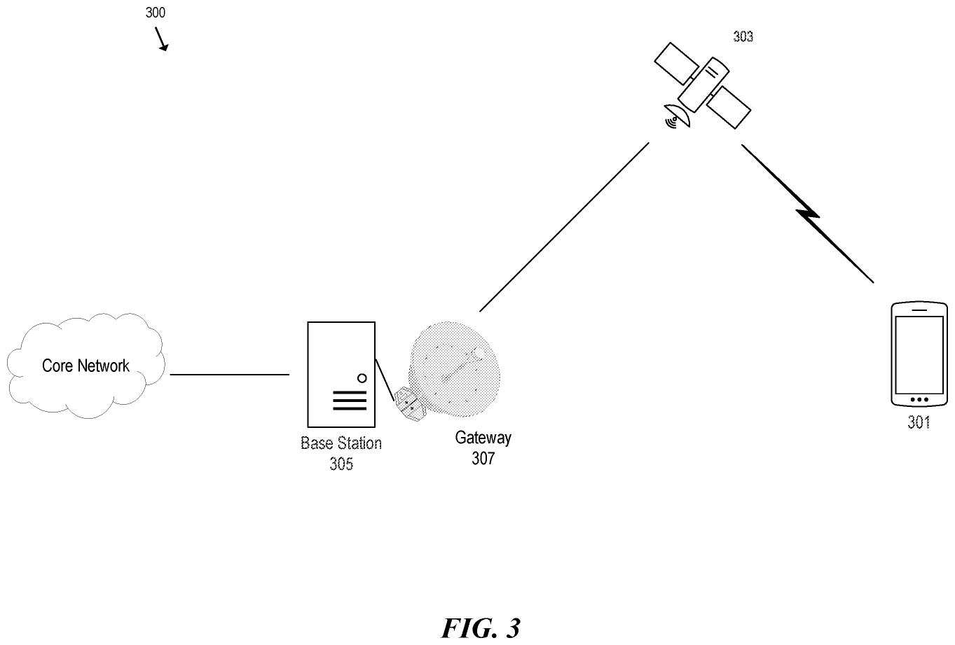

FIG. 3 illustrates an example configuration 300 of satellite network access in accordance with one or more embodiments of the present technology. As shown in FIG. 3, a user device 301 (also referred to as a terminal device, a mobile device, or a user equipment, UE) is in communication with a satellite access network via a satellite 303, which has an established Ground-Satellite link (GSL) with a base station 305 having a gateway 307.

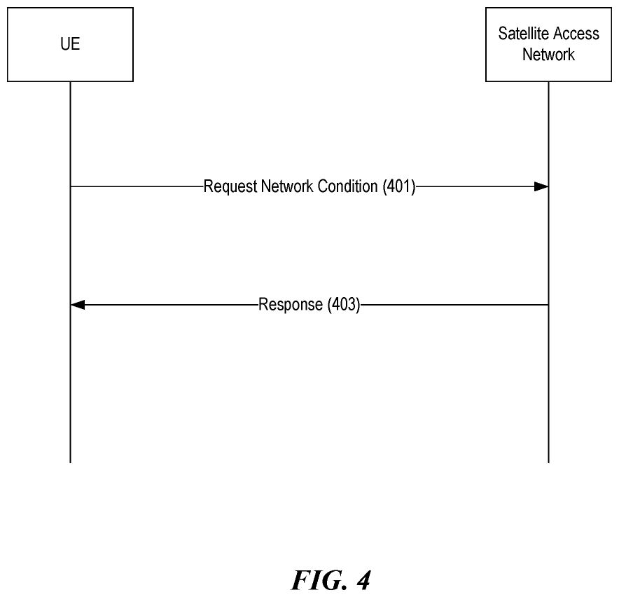

To be able to determine the appropriate level of service provided to the user (e.g., Short Message Service, SMS, only, call service only, SMS and call service only, and/or SMS, call service, and data service), the user device needs to be aware of the satellite network conditions. FIG. 4 illustrates an example signaling sequence for a user device to obtain satellite network conditions in accordance with one or more embodiments of the present technology. The UE establishes a radio GSL with a satellite access network. The UE can transmit a first signaling message 401 to request the network condition, such as information about network quality and/or capacity. The UE receives a response 403 including information about the network condition. The information can include indicators of the network condition, such as values related to UE configuration and/or measurement. For example, call sessions can be configured with a Quality of Service (QOS) value of 1 or 2, corresponding to certain threshold values such as packet delay budget and/or error rate. The information included in the response can indicate whether such threshold values are achievable or not at this point given the network capacity. The information can also include indicators indicating a bandwidth/capacity of the network at the time (e.g., a value of 1 representing bandwidth sufficient for text messages only, a value of 2 representing bandwidth sufficient for picture messages but not call service, etc.). Based on the information about the network condition, the UE can determine the appropriate service level available to the user. The UE can request the network condition periodically and/or upon triggered by user actions. For example, the UE can send the request when the user attempts to initiate a call session. In some cases, if the network condition is bad to a point that the UE cannot receive a proper response from the access network, the UE can completely restrict the service and queue any user requests (e.g., SMS messages, download/upload requests) to be processed in the future.

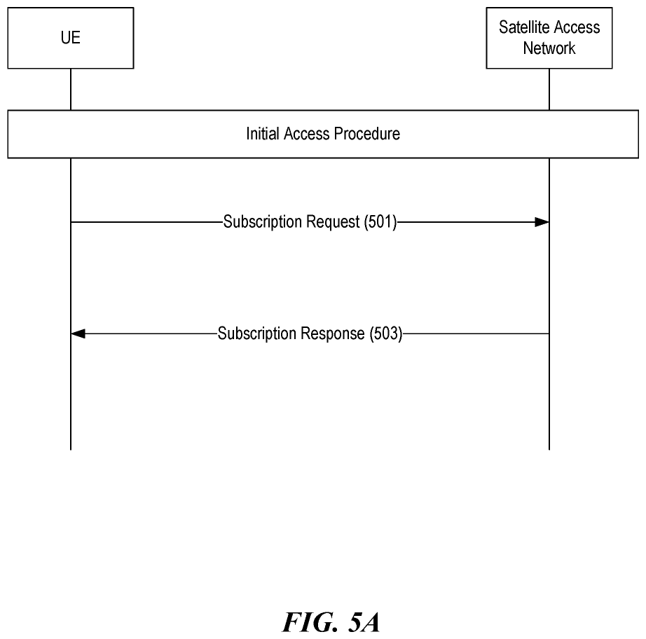

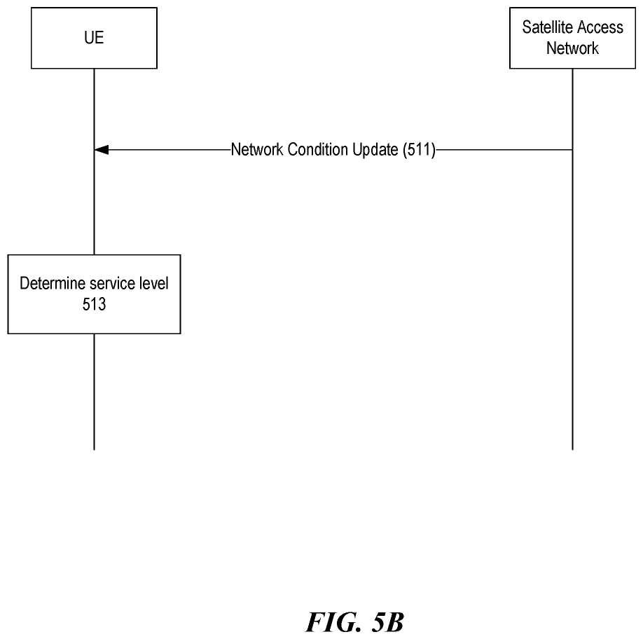

In some embodiments, actively requesting information (also referred to as pulling information) from the access network can place further burden on the network when the bandwidth is limited. FIG. 5A illustrates an example signaling sequence for a user device to subscribe satellite network conditions changes in accordance with one or more embodiments of the present technology. As shown in FIG. 5A, after the UE establishes the initial access with the satellite access network, the UE can transmit a subscription request 501 (e.g., using a default radio bearer) to the satellite network to subscribe to information about the network conditions. The satellite network can transmit a subscription response 503 back, indicating that the subscription is successfully. Upon detecting a change of the network conditions that impacts the available service levels (e.g., the network capacity suddenly drops due to a large amount of user requests, or the network capacity improves due to a reduced number of user requests), the access network can transmit a message (also referred to as pushing information) to the UE to inform the UE of the change. FIG. 5B illustrates an example signaling sequence for a user device to receive an update of network conditions in accordance with one or more embodiments of the present technology. The access network transmits the update message 511 to the UE so that the UE can determine the appropriate service level (513) given the update.

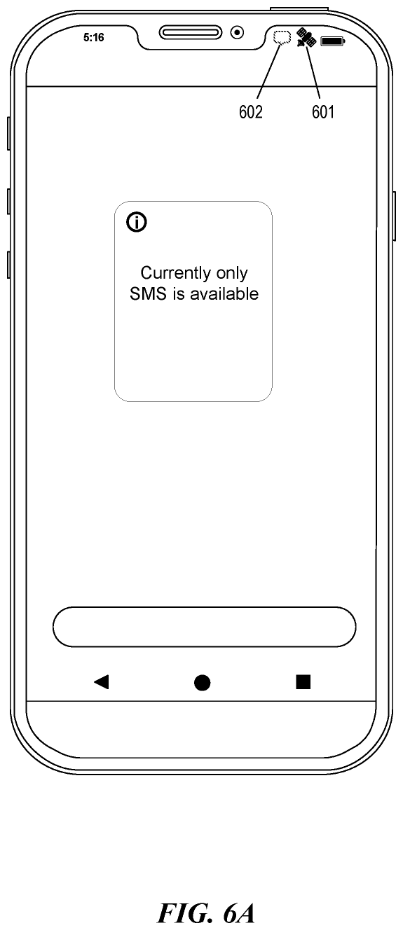

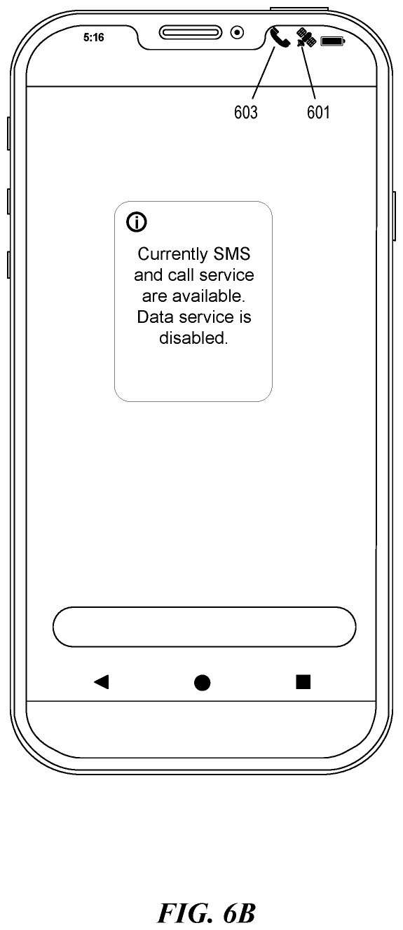

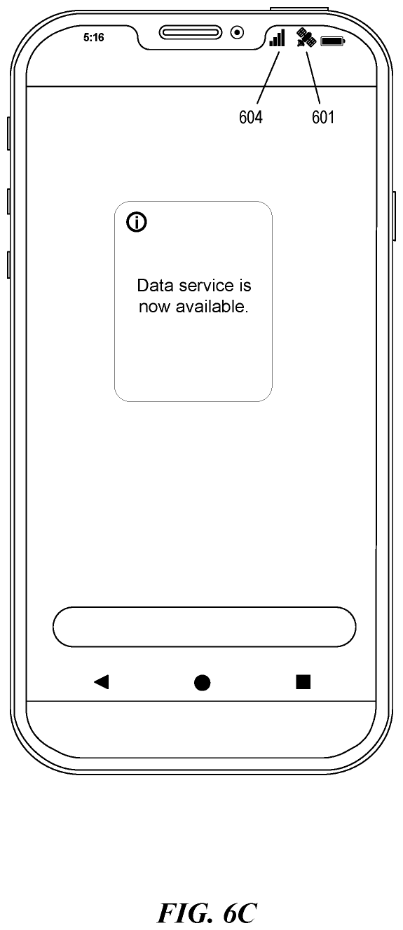

After the UE determines the available service level given the current network condition, learned either from pulling from or pushing by the network, the UE can notify the user of the service level via the user interface (UI). FIG. 6A illustrates an example UI on a mobile phone in accordance with one or more embodiments of the present technology. As shown in FIG. 6A, a first icon 601 indicates that the device is currently connected to a satellite network. Based on the network condition, the device can notify the user that only SMS is available at the time. The user can receive or send messages, but voice and data sessions are restricted due to the limited bandwidth of the network. A second icon 602 on the screen can be used to indicate the SMS-only status after the initial notification. In some embodiments, the service level has a finer granularity. For example, two levels of services can be provided for messaging: text messaging only, and text/picture messaging. Different icons can be used to indicate whether the network condition only allows text messaging only, or both text and picture messages are supported.

FIG. 6B illustrates another example UI on a mobile phone in accordance with one or more embodiments of the present technology. In this example, the network condition has improved to support both SMS and call service. However, data service is still restricted given the bandwidth situation (e.g., too many users are sharing the satellite bandwidth). The device displays a notification to the user, indicating that SMS and call service are available. A third icon 603 can be used to indicate the status after the initial notification.

FIG. 6C illustrates yet another example UI on a mobile phone in accordance with one or more embodiments of the present technology. In this example, the network condition has improved again to include support for data service. The device provides another prompt to notify the user that data service is now available. A fourth icon 604 can be used to indicate that data transmission is available. In some embodiments, the icon 604 can also indicate the bandwidth condition for performing data transmissions.

The examples sown in FIGS. 6A-6C depicts UI notifications at the Operating System (OS) level to provide users with information about the available service level(s) given the current conditions of the satellite access network. In some embodiments, such information can be made available to third-party applications installed on the user device to allow the applications to queue user requests for future processing. This way, user requests can be preserved when the network condition is poor, and be resumed (e.g., continued in the background) when the network condition enhances, thereby improving user experience.

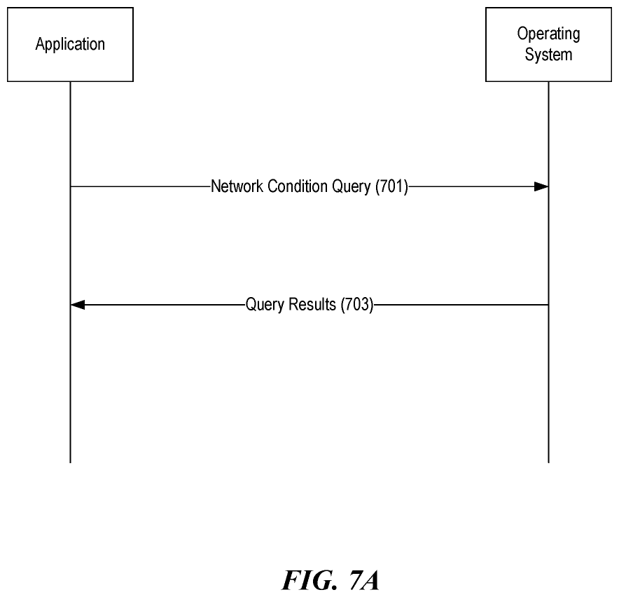

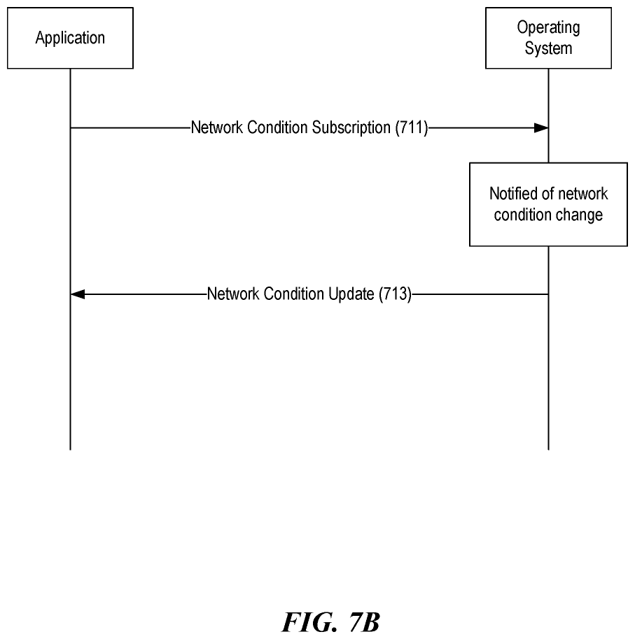

In some embodiments, a set of interfaces can be provided by the OS of the user device to allow applications installed on the user device to obtain and determine information about the network condition. FIG. 7A illustrates an example signaling sequence for an application to query the network condition from an operating system of a device in accordance with one or more embodiments of the present technology. The application can invoke the query interface 701 to obtain the current network conditions from the OS. The OS returns the query results 703 to the application to enable the application to determine appropriate actions on user requests. In some embodiments, applications installed on the user device can subscribe to network condition changes. FIG. 7B illustrates an example signaling sequence for an application to subscribe to network condition updates in accordance with one or more embodiments of the present technology. The application can invoke a subscription interface 711 to subscribe to network condition updates. When the user device receives notification of the network condition change (e.g., either by requesting information from the access network or by a notification from the access network), the operating system can send an update message 713 to the application(s) that have subscribed to the information. Upon being notified of the network condition update, the application can determine appropriate actions on user requests (e.g., allowing download, queuing download/upload requests, etc.).

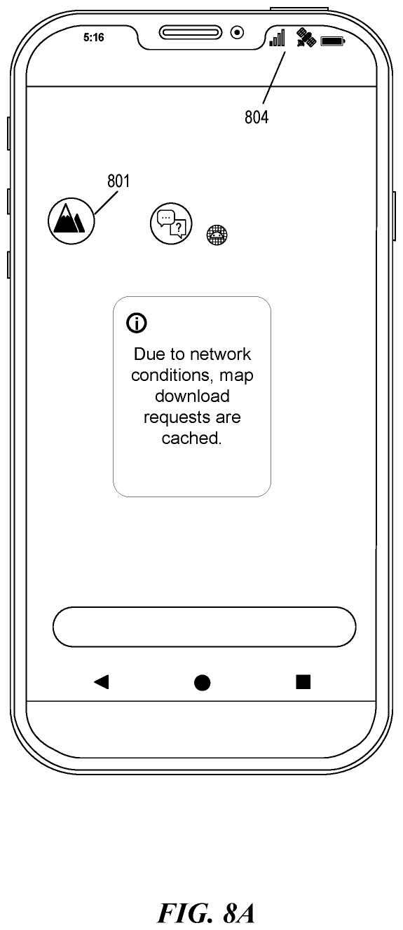

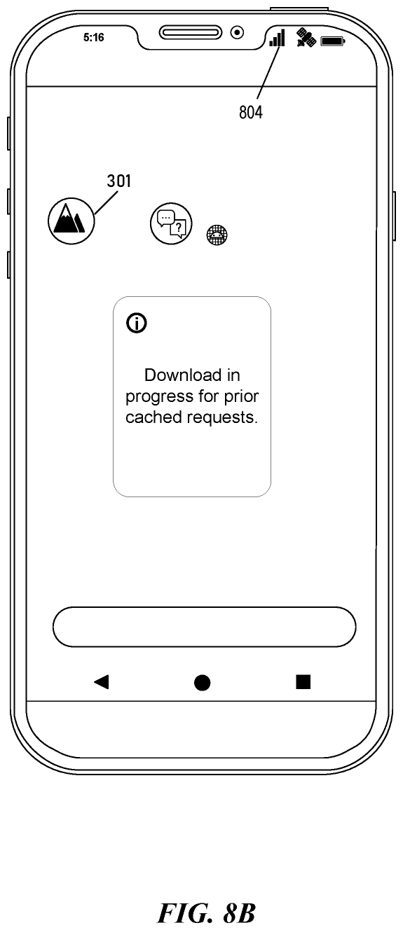

FIG. 8A illustrates an example UI on a mobile phone in accordance with one or more embodiments of the present technology. In this example, the user clicks on a shortcut icon 801 of an application to download a park map. The application is aware that the current network condition is not ideal—while data service is allowed (as shown in icon 804), the transmission speed can suffer due to poor network condition. The application then provides a prompt to the user, indicating that the map download request has been cached/queued. When the network condition improves, as shown by icon 804 in FIG. 8B, the application can provide another prompt to the user, indicating that the download is now in progress.

In some embodiments, the information about the network conditions is based on historical patterns of network condition and/or device locations within satellite coverage to enable the applications to make decisions on access to features. Using Yellowstone as an example again, the geolocation of the user device—Yellowstone—is associated with a historical pattern of usage/bandwidth availability. During daytime in summer, the demand for bandwidth is high given the large number of tourists in the area. However, at night (e.g., past midnight) or in winter months, the usage demand is low. Based on the historical patterns, the application can enable/disable features according to a combination of factors such as the geolocation of the device and/or the time of the request. When the user is in Yellowstone in the middle of winter and wants to post a picture to social media, the application knows that capacity in winter, and at night, in this location is very good according to the information provided by the operating system. The application then grants permission for user to post the photo. When a different user is in Yellowstone in August or on a weekend (peak tourist time) and wants to post a photo of bison crossing the road, the app blocks user from posting photos—based on information from the operation system—because only low bandwidth features like emergency texting can be enabled at this time.

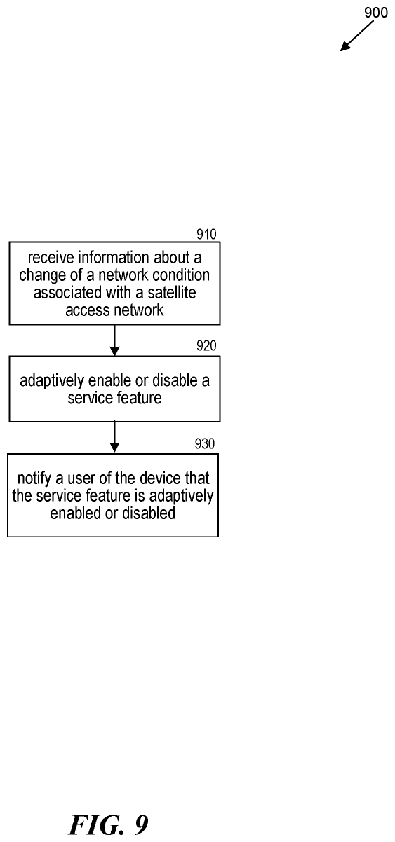

FIG. 9 is a flowchart representation of a method in accordance with one or more embodiments of the present technology. The method includes, at operation 910, receiving information about a change of a network condition associated with a satellite access network. The method 900 includes, at operation 920, adaptively enabling or disabling a service feature according to the change of the network condition. The method 900 also include, at operation 930, notifying a user of the device that the service feature is adaptively enabled or disabled.

In some embodiments, the method includes requesting the information about the change of the network condition from the satellite access network. In some embodiments, transmitting a subscription request to the satellite access network to subscribe to one or more change of the network condition and receiving the information about the change of the network condition in an update signaling from the satellite access network.

In some embodiments, the service feature comprises at least one of: a text messaging service feature, a picture messaging service feature, a voice call service feature, or a data service feature.

In some embodiments, the method includes displaying a notification to the user, via a user interface, notifying that service feature is adaptively enabled or disabled. In some embodiments, the method includes providing the information about the change of the network condition to an application installed on the device. In some embodiments, the method includes receiving a subscription request from the application to subscribe to one or more changes of the network condition.

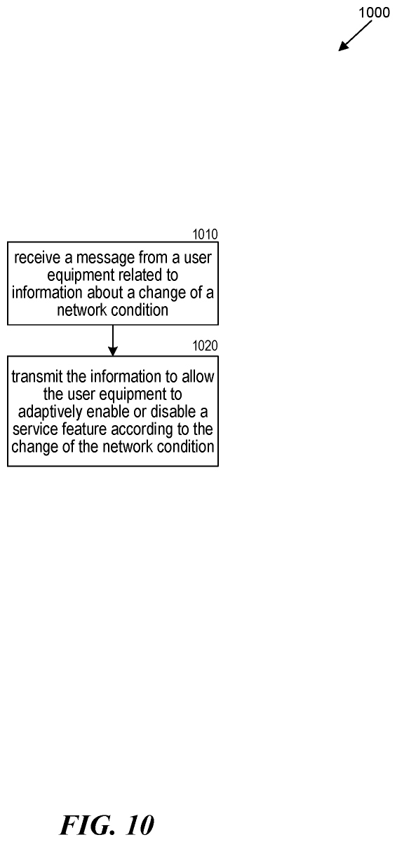

FIG. 10 is a flowchart representation of another method in accordance with one or more embodiments of the present technology. The method 1000 includes, at operation 1010, receiving, by a satellite access network, a message from a user equipment. The message is related to information about a change of a network condition associated with the satellite access network. The method 1000 includes, at operation 1020, transmitting, by the satellite access network, the information about the change of the network condition associated with the satellite access network to the user equipment to allow the user equipment to adaptively enable or disable a service feature according to the change of the network condition.

In some embodiments, the message comprises a request message configure to request the information about the change of the network condition associated with the satellite access network. In some embodiments, the message comprises a subscription request configured to subscribe to one or more changes of the network condition associated with the satellite access network. In some embodiments, the information about the change of the network condition is based on historical usage data associated with at least a location of the user equipment.

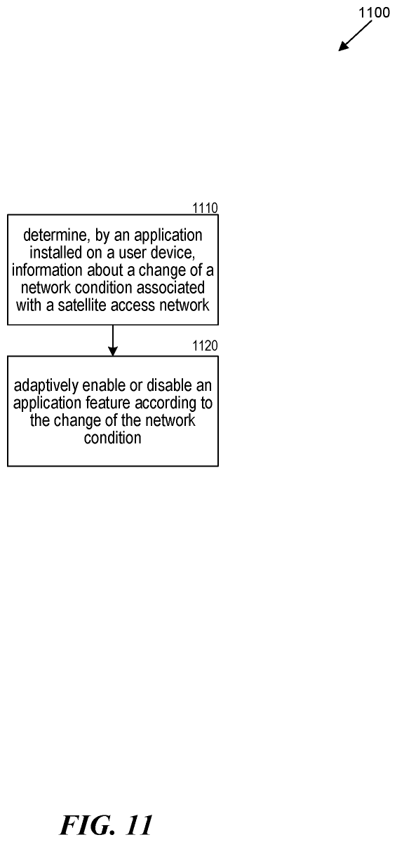

FIG. 11 is a flowchart representation of yet another method in accordance with one or more embodiments of the present technology. The method 1100 includes, at operation 1110, determining, by an application installed on a user device, information about a change of a network condition associated with a satellite access network. The method 1100 also includes, at operation 1120, adaptively enable or disable an application feature according to the change of the network condition.

In some embodiments, the method includes transmitting, by the application, a request to an operating system of the user device to request the information about the change of the network condition and receiving, by the application, the information about the change of the network condition from the operating system. In some embodiments, the method includes transmitting, by the application, a subscription request to an operating system of the user device to subscribe to one or more changes of the network condition.

In some embodiments, the application feature comprises at least one of: a feature that enables a user to upload data, or a feature that enables a user to download data. In some embodiments, the method includes postponing a download or an upload request from a user based on the network condition. In some embodiments, the method includes resuming, upon being notified of the change of the network condition, the download or the upload request.

In some embodiments, the information about the change of the network condition is based on historical data associated with at least a location of the user device. In some embodiments, the historical data comprises data usage pattern associated with the location of the user device. In some embodiments, the historical data is further associated with a time at which a user requests the application feature.

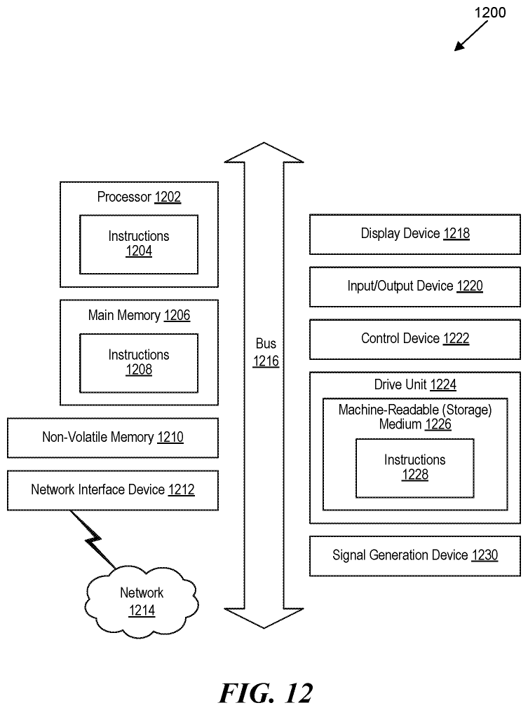

FIG. 12 is a block diagram that illustrates an example of a computer system 1200 in which at least some operations described herein can be implemented. As shown, the computer system 1200 can include one or more processors 1202, main memory 1206, non-volatile memory 1210, a network interface device 1212, a video display device 1218, an input/output device 1220, a control device 1222 (e.g., keyboard and pointing device), a drive unit 1224 that includes a machine-readable (storage) medium 1226, and a signal generation device 1230 that are communicatively connected to a bus 1216. The bus 1216 represents one or more physical buses and/or point-to-point connections that are connected by appropriate bridges, adapters, or controllers. Various common components (e.g., cache memory) are omitted from FIG. 12 for brevity. Instead, the computer system 1200 is intended to illustrate a hardware device on which components illustrated or described relative to the examples of the figures and any other components described in this specification can be implemented.

The computer system 1200 can take any suitable physical form. For example, the computing system 1200 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 1200. In some implementations, the computer system 1200 can be an embedded computer system, a system-on-chip (SOC), a single-board computer system (SBC), or a distributed system such as a mesh of computer systems, or it can include one or more cloud components in one or more networks. Where appropriate, one or more computer systems 1200 can perform operations in real-time, in near real-time, or in batch mode.

The network interface device 1212 enables the computing system 1200 to mediate data in a network 1214 with an entity that is external to the computing system 1200 through any communication protocol supported by the computing system 1200 and the external entity. Examples of the network interface device 1212 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 1206, non-volatile memory 1210, machine-readable medium 1226) can be local, remote, or distributed. Although shown as a single medium, the machine-readable medium 1226 can include multiple media (e.g., a centralized/distributed database and/or associated caches and servers) that store one or more sets of instructions 1228. The machine-readable medium 1226 can include any medium that is capable of storing, encoding, or carrying a set of instructions for execution by the computing system 1200. The machine-readable medium 1226 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 1210, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 1204, 1208, 1228) set at various times in various memory and storage devices in computing device(s). When read and executed by the processor 1202, the instruction(s) cause the computing system 1200 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A device for wireless communication, comprising at least one processor that is configured to:
operate in a geographic location where access to a network is provided via a satellite access network;
receive information about a satellite network condition associated with the satellite access network,
wherein the satellite network condition is based at least partially on a network usage pattern associated with the geographic location;
adaptively enable or disable a service feature according to the satellite network condition; and
display a notification to a user of the device, via a user interface, to notify the user that the service feature is adaptively enabled or disabled.

2. The device of claim 1, wherein the at least one processor is configured to:
request the information about the satellite network condition from the satellite access network.

3. The device of claim 1, wherein the at least one processor is configured to:
transmit a subscription request to the satellite access network to subscribe to one or more change of the satellite network condition; and
receive the information about a change of the satellite network condition in an update signaling from the satellite access network.

4. The device of claim 1, wherein the service feature comprises at least one of: a text messaging service feature, a picture messaging service feature, a voice call service feature, or a data service feature.

5. The device of claim 1, wherein the at least one processor is configured to:
provide the information about the satellite network condition to an application installed on the device.

6. The device of claim 5, wherein the at least one processor is configured to:
receive a subscription request from the application to subscribe to one or more changes of the satellite network condition.

7. The device of claim 1, wherein the information of the satellite network condition comprises values indicating whether a configured Quality of Service level is achievable or not.

8. A method for wireless communication, comprising:
receiving, by a satellite access network, a message from a user equipment, wherein the message is related to information about a satellite network condition associated with the satellite access network,
wherein the satellite network condition is based at least partially on a network usage pattern associated with a location of the user equipment; and
transmitting, by the satellite access network, the information about the satellite network condition associated with the satellite access network to the user equipment to allow the user equipment to adaptively enable or disable a service feature according to the satellite network condition.

9. The method of claim 8, wherein the message comprises a request message configure to request the information about the satellite network condition associated with the satellite access network.

10. The method of claim 8, wherein the message comprises a subscription request configured to subscribe to one or more changes of the satellite network condition associated with the satellite access network.

11. The method of claim 10, comprising:
transmitting, by the satellite access network to the user equipment in response to the subscription request, an update message indicating the one or more changes of the satellite network condition.

12. The method of claim 8, wherein the information about the satellite network condition is further based on a time at which the service feature is invoked.

13. A method for wireless communication, comprising:
determining, by an application installed on a user device, that the user device is operating in a geographic location where access to a network is provided via a satellite access network;
determining, by the application, information about a satellite network condition associated with the satellite access network,
wherein the satellite network condition is based at least partially on a network usage pattern associated with the geographic location;
adaptively enable or disable an application feature according to the satellite network condition; and
notifying a user of the user device, via a user interface of the user device, that the application feature has been adaptively enabled or disabled.

14. The method of claim 13, comprising:
transmitting, by the application, a request to an operating system of the user device to request the information about the satellite network condition; and
receiving, by the application, the information about the satellite network condition from the operating system.

15. The method of claim 13, comprising:
transmitting, by the application, a subscription request to an operating system of the user device to subscribe to one or more changes of the satellite network condition.

16. The method of claim 15, comprising:
receiving, by the application, an update response from the operating system of the user device indicating the one or more changes of the satellite network condition in response to the subscription request.

17. The method of claim 13, wherein the application feature comprises at least one of: a feature that enables a user to upload data, or a feature that enables a user to download data.

18. The method of claim 13, comprising:
postponing a download or an upload request from a user based on the satellite network condition.

19. The method of claim 18, comprising:
resuming, upon being notified of the satellite network condition, the download or the upload request.

20. The method of claim 13, wherein the network usage pattern is further associated with a time at which a user requests the application feature.
